(19) United States
(12) Patent Application Publication
(10) Pub. No.: US 2014/0337171 A1
(43) Pub. Date: Nov. 13, 2014

(54) SYSTEM AND METHOD FOR CONSUMER-MERCHANT TRANSACTION ANALYSIS

(71) Applicant: The Toronto-Dominion Bank, Mississauga (CA)

(72) Inventors: Prabaharan SIVASHANMUGAM, Farmington Hills, MI (US); Lauren Van Heerden, Bedford, NH (US); Michael D. Cummins, Pickering (CA); Orin Del Vecchio, Richmond Hill (CA); Gunalan Nadarajah, Milton (CA)

(73) Assignee: The Toronto-Dominion Bank, Mississauga (CA)

(21) Appl. No.: 14/273,500

(22) Filed: May 8, 2014

Related U.S. Application Data
(60) Provisional application No. 61/820,880, filed on May 8, 2013.

(51) Int. Cl. G06Q 30/06; G06Q 20/40

(52) U.S. Cl. CPC G06Q 30/0609; G06Q 20/4016
USPC 705/26.35

(57) ABSTRACT

A system, method and computer program product that is capable of determining respective merchant behaviour scores and consumer behaviour scores. Merchant locations (e.g. point of purchase or other geographic or virtual locations), in association with which merchants and consumers conduct transactions, can be used to enhance behaviour scoring capabilities. A merchant location may be attributed a merchant behaviour score such as one determined in accordance with consumer behaviour/financial/risk metrics of consumers who conduct transactions with the location. A specific consumer may be attributed a consumer behaviour score determined in accordance with the respective merchant behaviour scores of locations with which the specific consumer conducts transactions.

### CROSS-REFERENCE TO RELATED APPLICATION

This application claims the benefit of priority to U.S. Provisional Patent Application No. 61/820,880, filed May 8, 2013, the entire disclosure of which is expressly incorporated herein by reference to its entirety.

### FIELD

The present disclosure relates to a system and computerized method for behaviour assessment through the analysis of consumer-merchant transactions, and more particularly, to determining behaviour scores for merchants and consumers.

### BACKGROUND

Financial institutions, credit granting entities, marketing agencies, merchants/retailers and third-party service providers conduct behaviour assessments of customers and/or potential customers to assess actual or potential behaviours in a given context. Behaviour assessment results may, for example, assist with decisions about: whether or not to offer certain services to a customer; whether or not to continue to provide such services to that customer; marketing approach; customer segmentation; fraud management/detection; and/or what terms will govern the providing of such services. One service example is using the behaviour assessment during credit applications where a credit history is not available (e.g., young, new to credit, new to country). Other credit-related or similar services may include loan services such as personal or other lines of credit, mortgage services, hold funds decisions (e.g. when awaiting for a check or other deposit/payment to clear), communication methods, fraud management/detection, promotional segments.

Behaviour assessment in the credit context may evaluate various factors to aid in determining a customer's ability to meet its obligations in accordance with particular terms. The credit extender desires a thorough understanding of the credit receiver including before extending credit and while credit is extended. Risk assessment is not limited to the credit context and may be performed for other banking and/or non-banking services (e.g. marketing approach, personal financial management advice) and for other types of entities.

### BRIEF DESCRIPTION OF THE DRAWINGS

In order that the subject matter may be readily understood, embodiments are illustrated by way of examples in the accompanying drawings, in which:

FIG. 1 is a block diagram of a communication network for determining, respectively, merchant location scores and consumer location scores, consistent with the disclosed embodiments;

FIG. 2 is a flowchart of an exemplary process for determining a merchant behaviour score, in accordance with the disclosed embodiments; and

FIG. 3 is a flowchart of an exemplary process for determining a consumer behaviour score, in accordance with the disclosed embodiments.

For convenience, like numerals in the description refer to like structures in the drawings,

### DETAILED DESCRIPTION

Reference will now be made in detail to embodiments of the present disclosure, examples of which are illustrated in the accompanying drawings. In this application, the use of the singular includes the plural unless specifically stated otherwise. In this application, the use of or means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, any section headings used herein are for organizational purposes only, and are not to be construed as limiting the subject matter described.

The disclosed embodiments include system, method and computer program product that are capable of determining respective merchant behaviour scores and consumer behaviour scores.

Merchant locations (e.g. point of purchase or other geographic or virtual locations), in association with which merchants and consumers conduct transactions, can be used to enhance behaviour scoring capabilities. A merchant location may be attributed a merchant behaviour score such as one determined in accordance with consumer financial/risk metrics of consumers who conduct transactions with the location. A specific consumer may be attributed a consumer behaviour score determined in accordance with the respective merchant behaviour scores of locations with which the specific consumer conducts transactions.

In some embodiments, an accuracy of consumer behaviour assessments may be enhanced by adding a positive or negative modifier, such as to traditional customer scores, where the modifier is based on merchants or geographic areas a consumer frequents. The disclosed embodiments may be configured to use of transaction data, including merchant location, as well as consumer risk details such as internal or 3^{rd} party risk scores, to provide further data with which to perform risk assessment. The enhanced risk assessment can contribute to marketing offers/campaigns/approach, credit decisions, fraud management/detection, hold funds, transactions authorizations, etc. to protect consumers and financial institutions.

In one embodiment, there is provided a computer-implemented method for analyzing consumer behaviour. The method comprises: determining, for a particular consumer, a consumer behaviour score in accordance with respective merchant behaviour scores of a plurality of merchant instances with which the particular consumer conducts transactions; and storing the consumer behaviour score to a data store for performing behaviour assessment of the consumer. The method may include performing behaviour assessment for a credit transaction with the consumer using the consumer behaviour score.

The method may include: receiving transaction data for transactions conducted by the particular consumer; determining the plurality of merchant instances in accordance with the transaction data; and obtaining the merchant behaviour scores. The consumer behaviour score may be computed from the merchant behaviour scores as weighted in response to the transaction data. A respective merchant behaviour score may be weighted in response to a weighting factor determined from transaction data for transactions between the particular consumer and merchant instance, the weighting factor responsive to one or more of: transaction frequency, transaction amount, time/date of transaction, products/services purchased and method of payment.

The method may include: determining for a plurality of merchant instances a respective merchant behaviour score using consumer behaviour/financial/risk data for customers conducting transactions with the respective merchant instance; and, storing the merchant behaviour score to a data store in association with the merchant instance.

Determining a respective merchant behaviour score for a plurality of merchant instances may, in certain aspects, be performed periodically.

The method may include receiving transaction data for transactions conducted with the plurality of merchant instances; determining the customers in accordance with the transaction data; and obtaining the consumer behaviour/financial/risk data for the customers.

A respective merchant behaviour score for a particular merchant instance may be computed from the consumer financial/risk data as weighted in response to the transaction data. Respective consumer behaviour/financial/risk data for a particular customer may be weighted in response to a weighting factor determined from transaction data for transactions between the particular customer and the merchant instance, the weighting factor responsive to one or more of: transaction frequency, transaction amount, time/date of transaction, products/services purchased and method of payment.

The method may determine a consumer behaviour score periodically. A particular merchant instance may be defined in accordance with a geographical location of a merchant associated with the transaction.

In additional embodiments, a system includes a computer having at least one processor and a memory storing instructions and data to configure the processor to perform the method.

In other embodiments a computer program product includes a tangible, non-transitory, computer-readable storage medium storing instructions for configuring at least one processor, when executed, to perform the method.

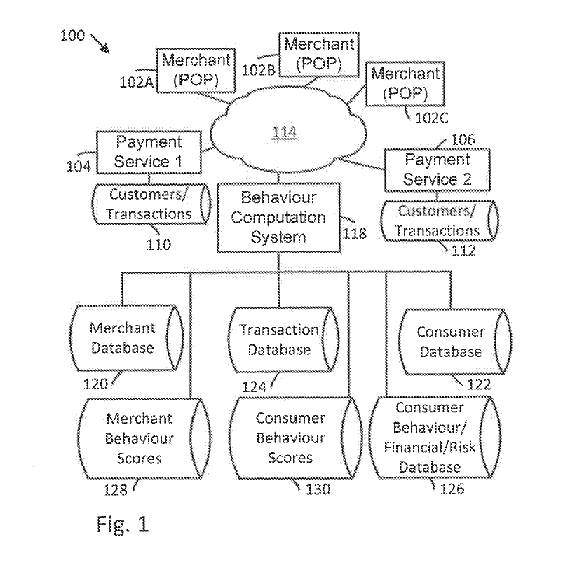

FIG. 1 is a block diagram of an example embodiment of a communication network 100 for determining, respectively, merchant behaviour scores and consumer behaviour scores. Purchase transactions may be conducted at a plurality of merchant locations as represented by merchant point of purchase (POP) locations 102A, 102B, 102C. A respective location may represent a geographic location of the merchant, such as a business location where products or services or both are sold or a virtual location (e.g. on-line business) where products or services or both are sold. Payment for the transaction may be made by credit card, debit card, on-line payment service (e.g. PayPal®), loyalty card, pre-paid gift card, cheque, mobile payment/mobile wallet, other traceable/accessible transaction method or the like, hereinafter generally referred to as a payment service.

A merchant may offer to receive payment by different payment services (e.g. Payment Service-1 and Payment Service-2), each payment service having a respective authorization service (104 and 106), and each of which payment service has a respective customer (e.g. cardholder) and transaction database (110 or 112). Transactions may be conducted via communications between a merchant POP (e.g. 102A, 102B or 102C) and a respective authorization service (104 or 106) over a network 114. Network 114 may be a public network, a private network or combination thereof and may comprise a wire infrastructure, a wireless infrastructure or a combination thereof. It will be appreciated that the payment infrastructure is simplified. For example, not shown are connections to various financial institutions and the like.

Transaction data collected may include:

Customer details

Date

Time

Location

Merchant

Transaction amount ($ or other currency)

Method of payment (debit, credit, “tap”, PIN)

Products/Services purchased

Individual transaction data may be aggregated (e.g. periodically) to compute additional data, such as the frequency with which a consumer transacts with a particular merchant (frequency), consumer spending habits or patterns, such as time and typical spending behaviour and spending by type of payment method.

Though not shown, consumers conducting the transactions may also be in communication with a merchant POP over a network (e.g. network 114 in a public configuration such as the Internet).

Transaction data associating merchants and consumers may be leveraged to determine merchant behaviour scores and consumer behaviour scores as further described.

A behaviour computation service 118 (such as provided by a system of one or more computers) may be configured to determine the merchant behaviour scores and consumer behaviour scores. In the present example, behaviour computation service 118 has access to a plurality of databases or other stores of data with which to determine the respective behaviour scores. There is shown merchant database 120, consumer database 122, transaction database 124, consumer behaviour/financial/risk database 126, merchant behaviour score database 128 and consumer behaviour score database 130. Though shown as separate databases, it will be appreciated that two or more of these databases may be combined. In some implementations, they may be implemented as respective tables or as one table in a same database or other store. For example, merchant database 120 and merchant behaviour scored database 128 may be combined. For example customer database 122 and customer behaviour scored database 130 may be combined, etc.

In one example, transaction database 124 may be populated with data received from the payment service authorization services (e.g. from respective databases 110 and 112) or other similar sources.

Behaviour computation service 118 may comprise one or more computers, such as servers, comprising or connected with one or more processors (e.g. microprocessors, etc.), memory, communication subsystems, input devices (keyboard, pointing device, microphone, buttons, printers), output devices (speaker, LEDS or other lights, display screen) and/or input/output devices (touch screen enabled display devices), storage devices, etc. Instructions and/or data stored in a tangible, non-transitory medium (e.g. memory (RAM or ROM) or a storage device (e.g. hard drive, flash drive, CD ROM, DVD ROM, etc.) may configure operations of the processor(s). Other embodiments are possible such as hardware-oriented (ASIC) embodiments.

It will be appreciated that communication network 100 is simplified. For example, not shown is various network infrastructure including routers, switches, firewalls, load balancers, gateways, etc.

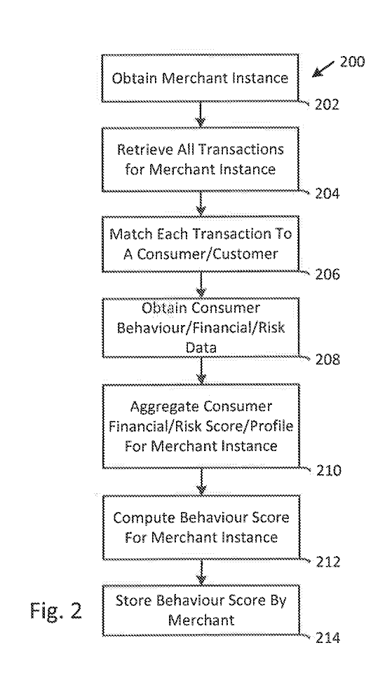

FIG. 2 is a flowchart illustrating operations 200 for determining a merchant behaviour score in accordance with an example. Operations 200 may be performed by behaviour computation service 118 (which, as described herein, may include a system of one or more computers). Operations 200 determine a merchant behaviour score for a specific merchant instance. It will be appreciated that merchant entities vary in size and complexity of their respective organizations and businesses. For example, a merchant may include a single retail location with a single POP device such as an independent retailer or service provider having a specific geographic location. A merchant may comprise a large multi-location, multi-service organization such as a chain of department stores selling a wide array of products and services. In some such instances, a single store location of the department store may have many POP devices. Some POP devices may be used for selling products and other POP devices for selling services in various departments or boutiques within the same store (geographic) location. Merchants may sell products and/or services on-line and customers purchase same. A transaction is not conducted at a geographic location of the merchant in the same sense as the consumer does not attend to the merchants “brick and mortar” location. However, transaction data may be captured and provide behaviour score assistance. It is understood then that “location” in relation to the behaviour score is a manner of providing granularity to the transactional relationship between the merchant and consumer.

Determining a merchant behaviour score for a particular merchant instance may be highly granular, for example, where such a score may be responsive to only transactions from a specific POP device instance at a geographic location (e.g. to separate sales of alcohol or other restricted products and services sold at a geographic location from other products and services sold there). In some examples, the merchant instance may be an aggregate of a subset of all POP devices at specific geographic location (e.g. POP devices associated with a specific department). In others, the merchant instance may be an aggregate of all POP devices at the specific geographic location (e.g. where a bank of cashiers are located at a common exit, each selling the same products and services).

At 202, behaviour computation service 118 may obtain a merchant instance, such as from merchant database 120. At 204, all transactions for the merchant instance are retrieved such as from transaction database 124. In some aspects, “all” is a relative term and may be understood to mean all transactions which are to inform the scoring. Transactions may be weighted in accordance with time for example. Transactions occurring more than X months earlier (e.g. relative to an effective calculation or score date, which need not be the actual date that operations 200 are performed) may have zero weight. Such transactions not be processed during the current calculation but would have been used in previous calculations. Those transactions occurring between X months or less may be weighted such that more current transactions may have more weight in the scoring. In other another model, transactions may be given equal weight. The choice of X months (or other period) may define the transaction window. The transactions may include different payment types as well, such as credit card, debit card, check, etc. and one or more types of same. Data in transaction database 124 may be gathered (aggregated) from other data stores associated with the payment types (e.g. 110 and 112 are representative).

Each transaction may be matched to a consumer from consumer database 122 with which to obtain a respective financial/risk score (e.g., 206). At 208, the consumer's behaviour/financial/risk score/profile may be obtained such as from consumer behaviour/financial/risk database 126. Consumer behaviour/financial/risk database 126 may be maintained and/or provided by the behaviour computation systems such as may be operated by a financial institution, etc. The consumer behaviour/financial/risk database 126 may be maintained by a third party service provider (not shown). The behaviour/financial/risk score profile may comprise communication preferences, past transactions, products and services purchased, balances, tenure, payment history, internal credit assessment, credit bureau, etc.

At steps 210 and 212, the consumer behaviour/financial/risk score and/or profile data for each transaction may be aggregated and a merchant behaviour score computed. The computation of the merchant behaviour score may be responsive to various factors such as frequency, transaction amount, method of payment, etc. A respective consumer behaviour/financial/risk score from a transaction may be weighted to determine the merchant's respective merchant behaviour score. For example, a consumer spending $1000 and having a high consumer behaviour score may be given a higher weight, responsive to the amount spent, than another consumer spending $10 that has a lower behaviour score. The computation may be responsive to various factors. A weighting factor can be determined from transaction data. The weighting factor may be responsive to one or more of: transaction frequency, transaction amount, time/date of transaction, products/services purchased and method of payment, etc. It is understood that a plurality of weighting factors may be determined. Also noted above is a weighting factor for how long ago the transaction took place (e.g. the data of the transaction relative to the effective calculation date). As an example, the following formula is weighted by the frequency of Customer visits: (customer A % of visits X score)+(customer B % of visits X score)+(customer C % of visits X score)+(customer D % of visits X score)=merchant score (e.g. at 212). In one example, the merchant's respective score may be used to further derive one or more other measures or modifiers. For example, the merchant score may be compared to preset segmentation or scale (which may not be linear) to derive a merchant modifier (e.g. a plus or minus value).

At 214, the merchant behaviour score (which includes any other derived measure or modifiers) is stored in association with the merchant (e.g. to database 128), such as for use to calculate respective consumer behaviour scores as described further.

Operations 200 may be performed periodically (e.g. daily, weekly, monthly, quarterly etc., or other period) or on demand.

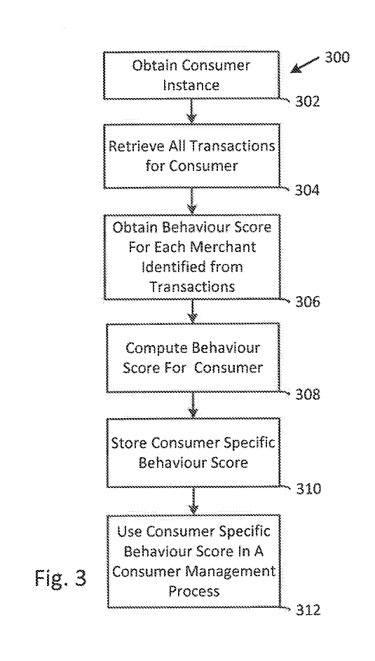

FIG. 3 is a flowchart illustrating operations 300 for determining a consumer behaviour score in accordance with an example. Operations 300 may be performed by behaviour computation service 118 (which, as described herein, may include a system of one or more computers). Operations 300 determine a consumer behaviour score for a specific consumer.

At 302, the consumer is obtained, such as from consumer database 122. At 304, the transactions for the consumer are obtained (e.g. identified within transaction database 124). Similar to the discussion in relation to operations 200, transactions may be weighted in response to how current they may be (e.g. date or transaction relative to effective calculation date). At 306, using the merchant information from the identified transactions, respective merchant behaviour scores are obtained (e.g. from database 128). At 308, the consumer behaviour score modifier is computed from the merchant behaviour score (or modifier) values. The computation may be responsive to various factors. A weighting factor can be determined from transaction data. The weighting factor may be responsive to one or more of: transaction frequency, transaction amount, time/date of transaction, products/services purchased and method of payment, etc. It is understood that a plurality of weighting factors may be determined. If no score/modifier is available for a particular merchant, the impact may be zero on the consumer score (neither positive nor negative). As an example, the following formula is weighted by the frequency of Customer visits: (merchant modifier A X % of customer A visits)+(merchant modifier B X % of customer A visits)+(merchant modifier C X % of customer A visits)+(merchant modifier D X % of customer A visits)=customer behaviour score modifier (e.g. at 308). In other examples, the merchant score rather than derived modifier may be used in a similar calculation and a customer modifier derived in a similar manner as discussed above.

Behavioural indicators can be extracted based on when a transaction is conducted, for example. An understanding of when a customer is actively shopping can be used for communication preferences, or identify potentially fraudulent activity. Products/services purchased may inform the behaviour score by identifying consumable goods (e.g., groceries, car service) versus assets (e.g., home improvement, vehicle purchase/upgrade). Products/services purchased could be used in the behaviour score in different ways, such as marketing offers, fraud management, etc.

At 310, the consumer behaviour score is stored in association with the consumer (e.g. to database 130), such as for use to in one or more consumer management processes (312). The score can be used in a credit context as a modifier to existing credit scoring (e.g., positive or negative application), or to replace current credit scoring capabilities where a credit history is not available (e.g., young, new to credit, new to country). Other uses for the behaviour score may be to inform customer management activities such as marketing offers, communication preferences, fraud management, communication methods, etc. The operations 300 may be performed periodically. Scores may be calculated for different periods as well such that a consumer may have more than one score, based on different transaction windows for example. The score may be a running average over a period of time (e.g., 6 months, 1 year, 5 years), where weighting could be applied based on how current the transaction is (i.e., most recent 3 months have a higher weighting than months 24 to 36).

In some aspects, the behaviour score modifier may be useful (e.g. at 312) to target various promotional or other information/offers. Assume an individual consumer has been targeted for an automobile offer for a manufacturer's mass market brand based on traditional analysis. The application of the behaviour score modifier would add increased precision, including the opportunity to change the offer to a manufacturer's premium brand from the mass market brand, in this application the behaviour score modifier has been used to determine that the customer's shopping behaviour is more consistent with the premium brand, or highlighted the method of customer contact, even though traditional metrics (e.g., income, residence, current vehicle, etc.) may indicate otherwise.

Certain aspects of the embodiments described herein include process steps and instructions described herein in the form of an algorithm. It should be noted that the process steps and instructions of the consistent with the disclosed embodiments can be embodied in software, firmware or hardware, and when embodied in software, can be downloaded to reside on and be operated from different platforms used by real time network operating systems.

Also described herein are exemplary systems and services for performing the operations herein. These systems and services may be specially constructed for the required purposes, or may include a general-purpose computer selectively activated or reconfigured by a computer program stored in the computer. Such a computer program may be stored in a tangible, non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

One or more embodiments have been described by way of example. It will be apparent to persons skilled in the art that a number of variations and modifications can be made. The scope of the claims should not be limited by the embodiments set forth in the examples, but should be given the broadest interpretation consistent with the description as a whole.

What is claimed is:

1. A computer-implemented method for analyzing consumer behaviour, the method comprising:
determining, using at least one processor, and for a particular consumer, a consumer behaviour score in accordance with respective merchant behaviour scores of a plurality of merchant instances with which the particular consumer conducts transactions, a respective merchant behaviour score determined using aggregated consumer behaviour/financial/risk data from customers conducting transactions with the respective merchant instance; and
storing, using the at least one processor, the consumer behaviour score to a data store for performing behaviour assessment of the consumer.

2. The method of claim 1, comprising performing behaviour assessment for a credit transaction with the consumer using the consumer behaviour score.

3. The method of claim 1, comprising:
receiving transaction data for transactions conducted by the particular consumer;
determining the plurality of merchant instances in accordance with the transaction data; and
obtaining the merchant behaviour scores.

4. The method of claim 3, comprising computing the consumer behaviour score from the merchant behaviour scores as weighted in response to the transaction data.

5. The method of claim 4, wherein a respective merchant behaviour score is weighted in response to a weighting factor determined from transaction data for transactions between the particular consumer and merchant instance, the weighting factor responsive to one or more of: transaction frequency, transaction amount, time/date of transaction, products/services purchased and method of payment.

6. The method of claim 1, comprising:
determining, for a plurality of merchant instances, a respective merchant behaviour score, aggregating consumer behaviour/financial/risk data for customers conducting transactions with the respective merchant instance, the consumer behaviour/financial/risk data comprising at least some of: balances data, tenure data, payment history data, internal credit assessment data and credit bureau data; and
storing the respective merchant behaviour score to a data store in association with each respective merchant instance.

7. The method of claim 6, wherein the step of determining for a plurality of merchant instances a respective merchant behaviour score is performed periodically.

8. The method of claim 6, comprising:
receiving transaction data for transactions conducted with the plurality of merchant instances;
determining the customers in accordance with the transaction data; and
obtaining the consumer behaviour/financial/risk data.

9. The method of claim 8, comprising computing a respective merchant behaviour score for a particular merchant instance from the consumer financial/risk score data as weighted in response to the transaction data.

10. The method of claim 9, wherein respective consumer behaviour/financial/risk score data for a particular customer is weighted in response to a weighting factor determined from transaction data for transactions between the particular customer and the merchant instance, the weighting factor responsive to one or more of: transaction frequency, transaction amount, time/date of transaction, products/services purchased and method of payment.

11. The method of claim 1, wherein the consumer behaviour score determined from respective merchant behaviour scores is a consumer credit score or consumer credit score modifier.

12. The method of claim 1, wherein a particular merchant instance is defined in accordance with a geographical location of a merchant associated with the transaction.

13. A computer system comprising at least one processor and a memory storing instructions and data to configure the at least one processor to:
determine, for a particular consumer, a consumer behaviour score in accordance with respective merchant behaviour scores of a plurality of merchant instances with which the particular consumer conducts transactions, a respective merchant behaviour score determined using aggregated consumer behaviour/financial/risk data from customers conducting transactions with the respective merchant instance; and
store the consumer behaviour score to a data store for performing behaviour assessment of the consumer.

14. The computer system of claim 13, wherein the processor is further configured to perform a behaviour assessment for a credit transaction with the consumer using the consumer behaviour score.

15. The computer system of claim 13 wherein the processor is further configured to:
receive transaction data for transactions conducted by the particular consumer;
determine the plurality of merchant instances in accordance with the transaction data; and
obtain the merchant behaviour scores.

16. The computer system of claim 15, wherein the processor is further configured to compute the consumer behaviour score from the merchant behaviour scores as weighted in response to the transaction data.

17. The computer system of claim 16, wherein a respective merchant behaviour score is weighted in response to a weighting factor determined from transaction data for transactions between the particular consumer and merchant instance, the weighting factor responsive to one or more of: transaction frequency, transaction amount, time/date of transaction, products/services purchased and method of payment.

18. The computer system of claim 13, wherein the processor is further configured to:
determine, for a plurality of merchant instances, a respective merchant behaviour score aggregating consumer behaviour/financial/risk data for customers conducting transactions with the respective merchant instance, the consumer behaviour/financial/risk data comprising at least some of: balances data, tenure data, payment history data, internal credit assessment data and credit bureau data; and
store the respective merchant behaviour score to a data store in association with each respective merchant instance.

19. The computer system of claim 13, wherein the consumer behaviour score determined from respective merchant behaviour scores is a consumer credit score or consumer credit score modifier.

20. A computer program product comprising a tangible, non-transitory computer-readable storage medium storing instructions, which when executed by at least one processor, cause the at least one processor of a computer system to:
determine, for a particular consumer, a consumer behaviour score in accordance with respective merchant behaviour scores of a plurality of merchant instances with which the particular consumer conducts transactions, a respective merchant behaviour score determined using aggregated consumer behaviour/financial/risk data from customers conducting transactions with the respective merchant instance, the consumer behaviour/financial/risk data comprising at least some of: balances data, tenure data, payment history data, internal credit assessment data and credit bureau data and the consumer behaviour score comprising a consumer credit score or consumer credit score modifier; and
store the consumer behaviour score to a data store for performing behaviour assessment of the consumer.
